(19) United States
(12) Patent Application Publication
(10) Pub. No.: US 2014/0229224 A1
(43) Pub. Date: Aug. 14, 2014

(54) SCHEDULING BASED ON CUSTOMER TRACKING

(71) Applicant: INTERNATIONAL BUSINESS MACHINES CORPORATION, (US)

(72) Inventors: ANA PAULA APPEL, Sao Paulo (BR); Victor Fernandes Cavalcante, Sao Paulo (BR); Maira Athanazio De Cerqueira Gatti, Sao Paulo (BR); Rogerio Abreu, De Paula, Sao Paulo (BR); Claudio Santos, Pinhanez, Sao Paulo (BR)

(73) Assignee: INTERNATIONAL BUSINESS MACHINES CORPORATION, ARMONK, NY (US)

(21) Appl. No.: 13/765,176

(22) Filed: Feb. 12, 2013

(51) Int. Cl. G06Q 10/06

(52) U.S. Cl. CPC G06Q 10/06315
USPC 705/7.25; 705/7.12

(57) ABSTRACT

A method for predicting facility utilization includes individually tracking a location of a plurality of people moving within the facility. A future course of motion is predicted for each of the plurality of people based on the tracked location. It is determined when each of the plurality of people will arrive at a location of interest within the facility based on the corresponding predicted future courses of motion. A utilization over time of the location of interest is calculated based on an aggregation of the determinations of when each of the plurality of people will arrive at the location of interest.

### TECHNICAL FIELD

The present disclosure relates to scheduling and, more specifically, to scheduling base on customer tracking.

### DISCUSSION OF THE RELATED ART

Scheduling of personnel can be a difficult task for managers, especially in the retail sector where customer behavior can be difficult to predict. Overstaffing can lead to excessive costs, diversion of human resources from performing other important tasks and lack of competitiveness while understaffing can degrade customer experiences, tarnish brand and contribute to lost income.

Scheduling of personnel may include creating shift schedules for future work shifts as well as redeploying personnel to react to unexpected situations. For example, a supermarket may utilize a shift schedule to bring in employees at various times of day.

The shift schedule may be created by a manager who determines a level of staffing to procure based generally on past experiences and recent observation. This approach generally involves a fair amount of trial and error and waste and inefficiencies may be common. Moreover, the degree of success a manager has with scheduling may vary from manager to manager.

Additionally, once a shift schedule has been created, there may still be unexpected changes in customer turnout that may necessitate reactionary changes such as calling in additional employees and redeploying employees already present. For example, a supermarket may receive an unexpected influx of customers and checkout lines may grow rapidly. The manager may then begin to call in additional employees and redeploy staff, however, by the time the checkout lines have grown long, the customer experience would have most likely already begun to suffer.

### SUMMARY

A method for predicting facility utilization includes individually tracking a location of a plurality of people moving within the facility. A future course of motion is predicted for each of the plurality of people based on the tracked location. It is determined when each of the plurality of people will arrive at a location of interest within the facility based on the corresponding predicted future courses of motion. A utilization over time of the location of interest is calculated based on an aggregation of the determinations of when each of the plurality of people will arrive at the location of interest.

The method may additionally include automatically generating a resource schedule for applying resources to the location of interest based on the calculated utilization over time. The method may additionally include automatically changing resource allocation for the location of interest based on the calculated utilization over time.

The facility may be a store, the plurality of people may be a plurality of shoppers, and the location of interest may include one or more checkout counters. The method may additionally include automatically generating a personnel schedule for applying personnel to the one or more checkout counters based on the calculated utilization over time. The method may additionally include automatically changing personnel allocation for the one or more checkout counters based on the calculated utilization over time.

The location of the plurality of people moving within the facility may be performed using one or more video cameras configured within the facility. The location of the plurality of people moving within the facility may be performed using one or more portable electronic devices carried by the plurality of people. The one or more portable electronic devices may include price check devices. The one or more portable electronic devices may include product locator devices. The one or more portable electronic devices may include tablet computers or smartphone devices.

The future course of motion may be predicted by matching the tracked location to a plurality of trained classifiers and determining when each of the plurality of people will arrive is performed based on the matched classifiers.

A method for predicting checkout counter utilization includes individually tracking a location of a plurality of shoppers moving within a store. A future course of motion for each of the plurality of shoppers is predicted based on the tracked location. It is determined when each of the plurality of shoppers will arrive at a checkout counter based on the corresponding predicted future courses of motion. A utilization over time of the location of the checkout counter is calculated based on an aggregation of the determinations of when each of the plurality of shoppers will arrive at the checkout counter. A personnel schedule for the store is automatically created or modified in response to the calculated utilization over time.

Automatically creating or modifying the personnel schedule for the store in response to the calculated utilization over time may include deploying additional personnel to operate the checkout counter at a time that is calculated to be a high utilization.

Location of the plurality of shoppers moving within the store may be performed using one or more video cameras configured within the store.

The location of the plurality of shoppers moving within the store may be performed using one or more portable electronic devices carried by the plurality of shoppers.

The future course of motion may be predicted by matching the tracked location to a plurality of trained classifiers and determining when each of the plurality of people will arrive is performed based on the matched classifiers.

A computer program product for predicting facility utilization includes a computer readable storage medium having program code embodied therewith. The program code is readable/executable by a computer to individually track a location of a plurality of people moving within the facility, predict a future course of motion for each of the plurality of people based on the tracked location, determine when each of the plurality of people will arrive at a location of interest within the facility based on the corresponding predicted future courses of motion, and calculate a utilization over time of the location of interest based on an aggregation of the determinations of when each of the plurality of people will arrive at the location of interest.

A personnel schedule may be generated for applying personnel to the location of interest based on the calculated utilization over time.

Personnel allocation for the location of interest may be automatically changed based on the calculated utilization over time.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a flow chart illustrating an approach for automated personnel scheduling in accordance with exemplary embodiments of the present invention;

FIG. 2 is a schematic diagram illustrating a system for automated personnel scheduling in accordance with exemplary embodiments of the present invention;

FIG. 3 is a schematic diagram illustrating a method workflow for performing automated scheduling based on customer tracking in accordance with exemplary embodiments of the present invention;

FIG. 4A is a flow chart illustrating a workflow for learning system training in accordance with exemplary embodiments of the present invention;

FIG. 4B is a flow chart illustrating a runtime workflow for performing personnel scheduling in accordance with exemplary embodiments of the present invention; and

FIG. 5 shows an example of a computer system capable of implementing the method and apparatus according to embodiments of the present disclosure.

### DETAILED DESCRIPTION OF THE DRAWINGS

In describing exemplary embodiments of the present disclosure illustrated in the drawings, specific terminology is employed for sake of clarity. However, the present disclosure is not intended to be limited to the specific terminology so selected, and it is to be understood that each specific element includes all technical equivalents which operate in a similar manner.

Exemplary embodiments of the present invention provide a system and method for automatic personnel scheduling. Rather than relying solely on data pertaining to past numbers of customers, checkout line wait times, and the knowledge and experience of managers, exemplary embodiments of the present invention seek to track customer's in-store behavior, model the behavior and effectively estimate the needs of each customer so that appropriate staffing may be provided when it is needed. By providing the appropriate staffing at or prior to the moment of need, as opposed to after large lines have formed, personnel may be more efficiently deployed and customer experience may be improved.

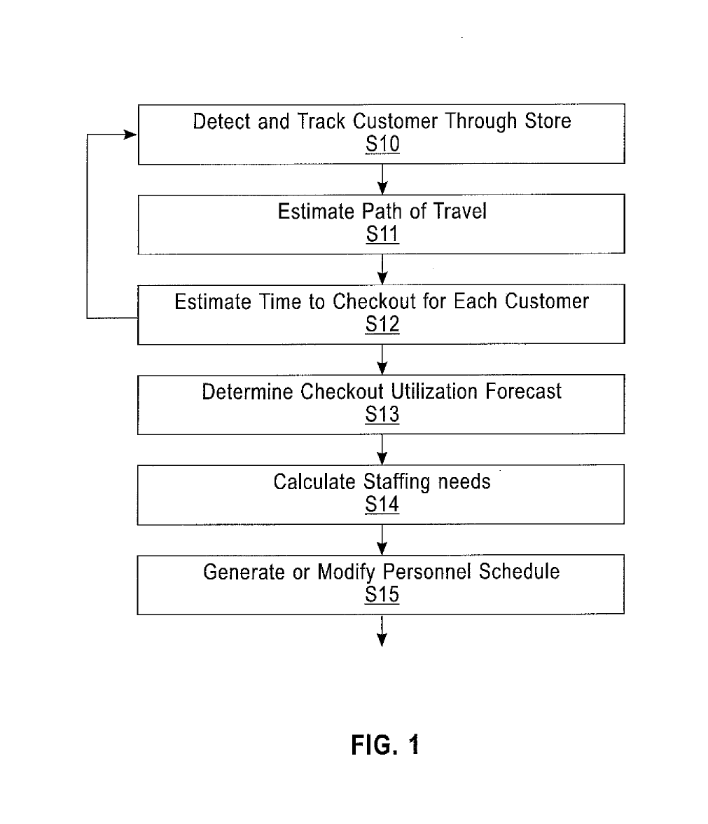

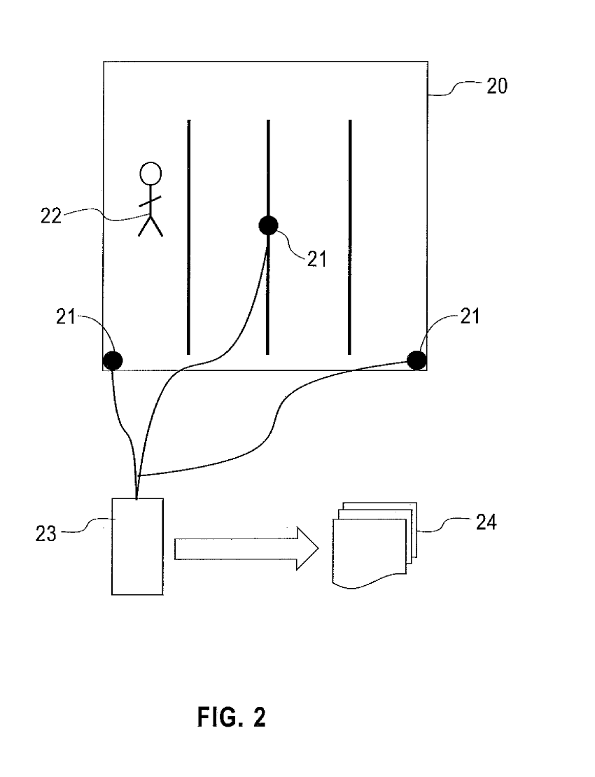

FIG. 1 is a flow chart illustrating an approach for automated personnel scheduling in accordance with exemplary embodiments of the present invention. FIG. 2 is a schematic diagram illustrating a system for automated personnel scheduling in accordance with exemplary embodiments of the present invention. First, customers may be detected and tracked (Step S10). Detection and tracking may be performed using one or more detection techniques. By utilizing multiple detection approaches, greater data accuracy may be assured. While any available detection and tracking techniques may be used, one example utilizes video surveillance. Many stores already maintain video surveillance equipment. Video surveillance equipment may include a network of video cameras 21 disposed at multiple locations throughout the facility 20, which may be, for example, a retail store such as a supermarket. The network of video cameras 21 may be connected to a computer system 23 or other data processing device for identifying one or more unique shoppers 22 within the store 20 and tracking their movement throughout the store 20. As the same person may be simultaneously detected by multiple video cameras, the computer system must first identify unique people so that their position may be tracked throughout the store.

Rather than relying on video surveillance equipment, or in addition to it, various other techniques may be used to detect and track shoppers. For example, each shopper may be tracked by a transmission device disposed in a shopping cart or shopping basket. Transmission from the transmission device may be detected and triangulated using a set of transmission detection devices. The transmission device may either be incorporated into the shopping basket/cart directly or as part of a computer terminal that serves some other purpose such as to help the shopper with performing price checks, locating desired products, etc. For example, the transmission device may be a beacon that emits an easily detectable radio frequency signal, infrared light signal, etc. Alternatively, the transmission device may be a portable computational device such as a tablet computer that is capable of identifying its own position within the store, for example, by the use of GPS, triangulation of signals received from stationary beacons, strength of Wi-Fi signals, etc. and communicating the determined location to the computer system 23. While such portable computing devices may be made available to the customers upon entry into the facility, the customers may also be detected and tracked by their own personal smart phones and tablet computers in a similar manner, for example, by running an application thereon designed for providing one or more valuable services to the customer such as price checking and product identification.

A probable path of travel may be estimated based on the customer tracking (Step S11). This may be accomplished, for example, by matching the pattern of movement of each customer to a library of known common patterns. This matching may be performed, for example, by the application of one or more trained classifiers, which may be trained from training data including previous tracking of customers through the store. Moreover, even when the system is operational, the tracked pattern of movement of customers may be used as training data to bolster the trained classifiers.

By fitting the detected path of each customer to known paths using the trained classifiers, the computer system may estimate time to checkout for each customer (Step S12). The tracking of the customer (Step S10), the estimation of travel path (Step S11), and the estimation of time to checkout (Step S12) may be continued, for example, for the entire time the customer is in the store. This may provide for continuous updating of the estimated time to checkout. The estimated time to checkout for each customer detected in the store may be used to determine a checkout utilization forecast (Step S13). This maybe accomplished by collating the estimated time to checkout data for each point in time and determining how many customers are likely to be at the checkout location at any given point in time. Thereafter, a curve may be fitted to the checkout utilization forecast to provide smooth and continuous output.

The estimated travel paths for each customer may be probabilistic in nature. For example, multiple travel paths may be assigned to each customer along with a probability score for that path being followed by that customer. Then, in estimating time to checkout, a probability distribution may be calculated. The probability distribution may be a function of expected checkout time in terms of its probability. The checkout utilization forecast may then be determined by taking a weighted average of the estimated checkout time for each shopper weighed in accordance with its estimated probability. Staffing needs over time may then be calculated based on the utilization forecast (Step S14). In calculating the staffing needs, a personnel shift schedule 24 may be generated or an existing schedule modified in real-time (Step S15). Generation of the personnel schedule may rely on extrapolating longer-term trends from the utilization forecasts. However, real-time modification may be used to call upon staff on-call or to redeploy staff from one post to another.

In addition to, or instead of, estimating time to checkout, exemplary embodiments of the present invention may be used to determine staffing at a particular department, where, for example, the tracking and fitting may be used to estimate when individual shoppers may arrive within a particular store department.

As discussed above, exemplary embodiments of the present invention focus on the tracking and path prediction of individual customers within the store facility. The movement of the individual customers is fit to a model and an estimate of their future time of arrival at a given point of interest is estimated. The aggregate staffing needs at that point of arrival is then determined based on the set of individual estimated times of arrival at the point of interest.

The fitting of the customer's estimated path of travel need not be based entirely on the tracking of the customer's movements. Other factors may be considered in addition or in place of this data. The other factors may include, for example, information pertaining to the products currently placed in the customer's shopping cart, a customer's electronic shopping list, survey data, past personal shopping data, etc. Past personal shopping data may be determined, for example, by savings card accounts which may be associated with a portable electronic device carried by the customer though the store, as described above, or the customer may be asked at the time of entry to provide a savings card to a console, for example, in response to an offer for customized sales and/or coupons.

Exemplary embodiments of the present invention need not be limited to use in shopping facilities. The movement of people though other facilities such as museums, amusement parks, and any other indoor or outdoor facility may be similarly used to estimate staffing needs at various locations or to provide desired services. Moreover, exemplary embodiments of the present invention are not limited to forecasting movement for the purposes of store checkout. Other purposes may be served, such as identifying desired/wanted products for re-shelving prior to customer departure, offering products of interest to customers to enhance “consuming paths”, recalculating estimation of check-out based on suggested alternative consuming paths, etc.

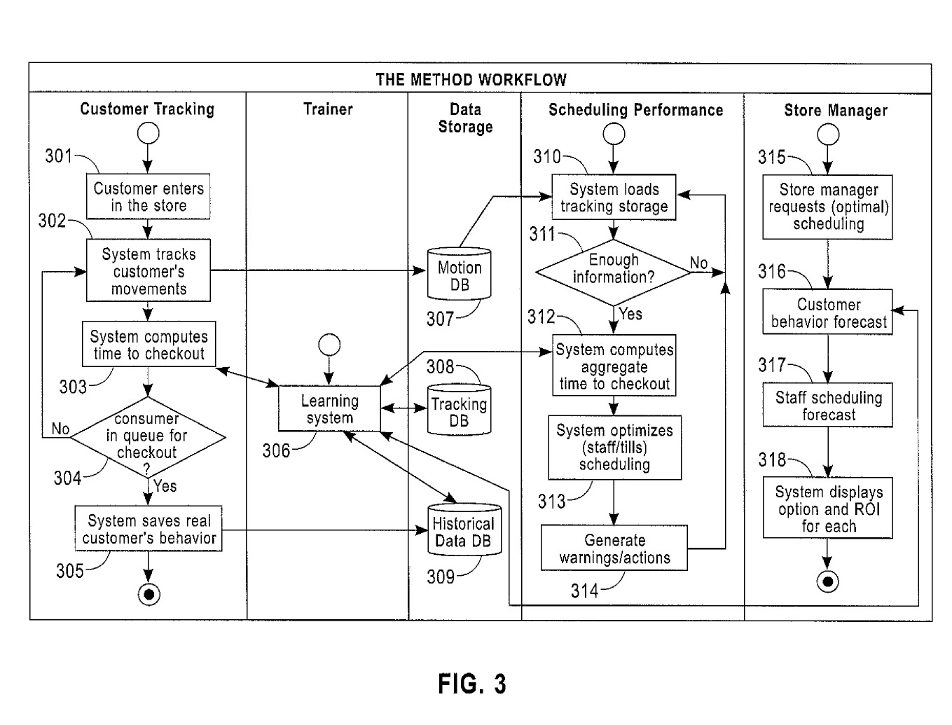

FIG. 3 is a schematic diagram illustrating a method workflow for performing automated scheduling based on customer tracking in accordance with exemplary embodiments of the present invention. The entry of a customer or other tracked person into the store or other facility may be detected (301). The system may track the customer's position and/or movements throughout the store (302). The tracked movements may be stored in a motion database 307. The system may estimate a time-to-checkout for the tracked person (303). For as long as the customer is not detected to be in a checkout line (No, 304), the customer may continue to be tracked 302. When the customer is detected to be in a checkout line (Yes, 304), the system may save the complete customer behavior to a historical data database 309. A plurality of customers may be so tracked.

A learning system 306 may be used to learn patterns of customer behavior and use this information to provide the time-to-checkout based on the learned patterns. In learning patterns of customer behavior, the learning system 306 may utilize customer behavior data from the historical data database 309, training data from a training database 309, and an indication of aggregate time-to-checkout 312.

In performing automated scheduling, the system may load tracking data 310 from the motion database 307. It may be determined whether there is sufficient tracking data to compute aggregate checkout time. Where sufficient data has not been collected (No, 311), further information may be loaded 310. Where sufficient data has been collected (Yes, 311), the system may compute aggregate time-to-checkout 312. Aggregate time-to-checkout may be a combination of time-to-checkout data for a plurality of customers, for example, all customers within the store at the given time. Thereafter, the system may optimize staffing schedules 313. Where automated or self-checkout tills are used, the system may optimize till openings. Optimization of the staffing schedules may include calling in stand-by employees and/or redeploying available employees. Various warnings and/or actions may be taken 314 when there is a mismatch between the employees needed and the employees available. For example, a warning of insufficient staffing may be generated and sent to one or more store managers and/or on-call employees may be sent messages to report to the store.

Optimal scheduling may be performed periodically and/or at the request of a store manager 315. Optimal scheduling may be used not only to optimize staffing in real-time but also to generate future staffing schedules based on historical data. The store manager may also use the system to forecast customer behavior 316. Forecasting of customer behavior may include predicting when and how many customers will enter the store, how busy the store may be at any given time, which items may need to be restocked and at what point, and what paths through the store may be taken by various customers so that targeted promotions and offers may be setup and optimal product arrangement may be developed. Exemplary embodiments of the present invention may be used to forecast staff scheduling needs and where desired, these forecasts may be used by a store manager to manually develop a personnel schedule. The system may also display a set of staffing options to the manager along with associated costs and benefits 318 so the manager may better make personnel scheduling decisions.

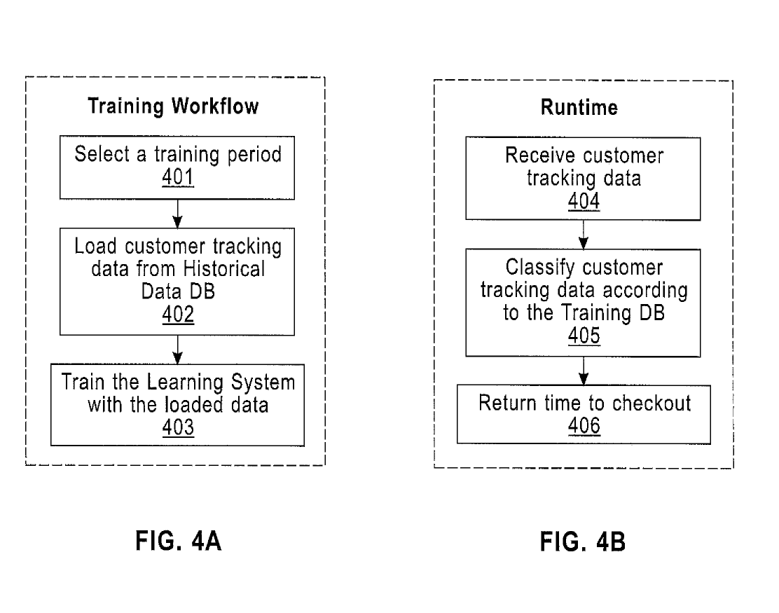

FIG. 4A is a flow chart illustrating a workflow for learning system training in accordance with exemplary embodiments of the present invention. First a training period may be selected 401. The training period may simply be a maximum set of data or the training period may be a span of time since one or more changes have been made to the store or events occurred to justify a belief that subsequent data would not be of sufficient predictive value. Customer tracking data may then be loaded from the historical data database 402. The learning system may then be trained using the loaded training data 403.

FIG. 4B is a flow chart illustrating a runtime workflow for performing personnel scheduling in accordance with exemplary embodiments of the present invention. Customer tracking data may be received 404. Customer tracking data may then be classified according to the data of the training database 405. Classification may include matching the customer tracking data to one or more known classifiers. A time-to-checkout may be returned 406 based on the properties of the classification. As discussed above, the time-to-checkout for multiple customers may be aggregated to determine checkout utilization and/or congestion.

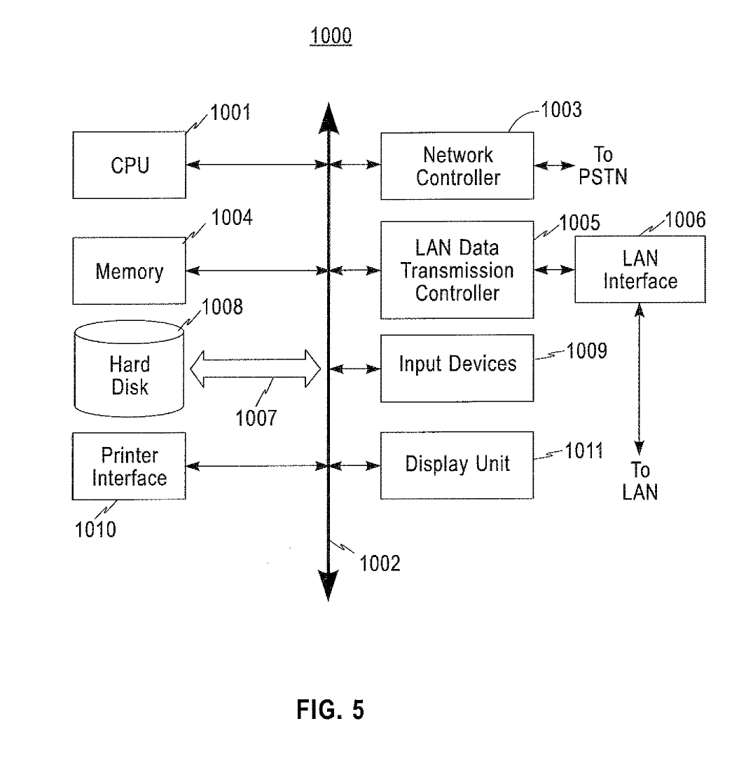

FIG. 5 shows an example of a computer system which may implement a method and system of the present disclosure. The system and method of the present disclosure may be implemented in the form of a software application running on a computer system, for example, a mainframe, personal computer (PC), handheld computer, server, etc. The software application may be stored on a recording media locally accessible by the computer system and accessible via a hard wired or wireless connection to a network, for example, a local area network, or the Internet.

The computer system referred to generally as system 1000 may include, for example, a central processing unit (CPU) 1001, random access memory (RAM) 1004, a printer interface 1010, a display unit 1011, a local area network (LAN) data transmission controller 1005, a LAN interface 1006, a network controller 1003, an internal bus 1002, and one or more input devices 1009, for example, a keyboard, mouse etc. As shown, the system 1000 may be connected to a data storage device, for example, a hard disk, 1008 via a link 1007.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Exemplary embodiments described herein are illustrative, and many variations can be introduced without departing from the spirit of the disclosure or from the scope of the appended claims. For example, elements and/or features of different exemplary embodiments may be combined with each other and/or substituted for each other within the scope of this disclosure and appended claims.

What is claimed is:

1. A method for predicting facility utilization, comprising:
individually tracking a location of a plurality of people moving within the facility;
predicting a future course of motion for each of the plurality of people based on the tracked location;
determining when each of the plurality of people will arrive at a location of interest within the facility based on the corresponding predicted future courses of motion; and
calculating a utilization over time of the location of interest based on an aggregation of the determinations of when each of the plurality of people will arrive at the location of interest.

2. The method of claim 1, additionally comprising automatically generating a resource schedule for applying resources to the location of interest based on the calculated utilization over time.

3. The method of claim 1, additionally comprising automatically changing resource allocation for the location of interest based on the calculated utilization over time.

4. The method of claim 1, wherein the facility is a store, the plurality of people are a plurality of shoppers, and the location of interest includes one or more checkout counters.

5. The method of claim 4, additionally comprising automatically generating a personnel schedule for applying personnel to the one or more checkout counters based on the calculated utilization over time.

6. The method of claim 4, additionally comprising automatically changing personnel allocation for the one or more checkout counters based on the calculated utilization over time.

7. The method of claim 1, wherein the location of the plurality of people moving within the facility is performed using one or more video cameras configured within the facility.

8. The method of claim 1, wherein the location of the plurality of people moving within the facility is performed using one or more portable electronic devices carried by the plurality of people.

9. The method of claim 8, wherein the one or more portable electronic devices include price check devices.

10. The method of claim 8, wherein the one or more portable electronic devices include product locator devices.

11. The method of claim 8, wherein the one or more portable electronic devices include tablet computers or smartphone devices.

12. The method of claim 1, wherein the future course of motion is predicted by matching the tracked location to a plurality of trained classifiers and determining when each of the plurality of people will arrive is performed based on the matched classifiers.

13. A method for predicting checkout counter utilization, comprising:
individually tracking a location of a plurality of shoppers moving within a store;
predicting a future course of motion for each of the plurality of shoppers based on the tracked location;
determining when each of the plurality of shoppers will arrive at a checkout counter based on the corresponding predicted future courses of motion;
calculating a utilization over time of the location of the checkout counter based on an aggregation of the determinations of when each of the plurality of shoppers will arrive at the checkout counter; and
automatically creating or modifying a personnel schedule for the store in response to the calculated utilization over time.

14. The method of claim 13, wherein automatically creating or modifying the personnel schedule for the store in response to the calculated utilization over time includes deploying additional personnel to operate the checkout counter at a time that is calculated to be a high utilization.

15. The method of claim 13, wherein location of the plurality of shoppers moving within the store is performed using one or more video cameras configured within the store.

16. The method of claim 13, wherein the location of the plurality of shoppers moving within the store is performed using one or more portable electronic devices carried by the plurality of shoppers.

17. The method of claim 13, wherein the future course of motion is predicted by matching the tracked location to a plurality of trained classifiers and determining when each of the plurality of people will arrive is performed based on the matched classifiers.

18. A computer program product for predicting facility utilization, the computer program product comprising a computer readable storage medium having program code embodied therewith, the program code readable/executable by a computer to:
individually track a location of a plurality of people moving within the facility;
predict a future course of motion for each of the plurality of people based on the tracked location;
determine when each of the plurality of people will arrive at a location of interest within the facility based on the corresponding predicted future courses of motion; and
calculate a utilization over time of the location of interest based on an aggregation of the determinations of when each of the plurality of people will arrive at the location of interest.

19. The computer program product of claim 18, wherein a personnel schedule is generated for applying personnel to the location of interest based on the calculated utilization over time.

20. The computer program product of claim 18, wherein personnel allocation for the location of interest is automatically changed based on the calculated utilization over time.
